(19) United States
(12) Patent Application Publication
(10) Pub. No.: US 2004/0063368 A1
(43) Pub. Date: Apr. 1, 2004

(54) Micro tracker mouse pad

(76) Inventor: Jerrold Arthur Greiff, Kenmore, WA (US)

Correspondence Address: Jerrold Arthur Greiff, PMB 434, 6830 Bothell Way NE, Kenmore, WA, 98028, US

(21) Appl. No.: 10/670,296

(22) Filed: Sep. 26, 2003

Related U.S. Application Data
(60) Provisional application No. 60/413,462, filed on Sep. 26, 2002.

(51) Int. Cl. B32B 27/04; D04H 3/00; B32B 27/12; B32B 5/02; D03D 15/00

(52) U.S. Cl. 442/286; 442/104; 442/189; 442/293; 442/340; 442/394; 442/399

(57) ABSTRACT

We are submitting an application for a patent for a computer mouse pad that utilizes microfiber cloth as the surface material for the mouse pad. Microfiber is an advanced technology fiber, producing split wedge-shaped fibers of very fine denier, creating an expanded internal matrix that traps dirt more effectively and completely than any known fiber. Using microfiber cloth as the surface material for a mouse pad creates a major advance in the technology that attempts to eliminate dirt, dust and debris from entering the rollers inside inside the mouse via the trackball. The MicroTracker Mouse Pad thus solves one of the major problems associated with using computer mice with mechanical trackballs.

### FIELD OF ENDEAVOR

Class D14, Subclass #458: A flat surface that a mouse type is rolled against, i.e., a mouse pad.

### SPECIFICATION

A mouse pad is a flat, horizontal surface used either for rolling a ball mouse on or sliding an optical mouse on. Although a mouse can be operated on any flat surface, it is commonly used on a mouse pad, as they are supposed to provide better traction and a smooth lint-free surface over which to move.

Dirt naturally gets deposited on the surface of the mouse pad from the environment and the operation of the user. The problem with mouse pads is that the ball picks up these small dirt particles from the top surface of the mouse pad, and deposits them on the rollers inside the mouse. The ball needs to be composed of a rubber material to increase traction, which has the side-effect of the ball picking up dirt. As the ball glides over the surface, gradually so much dirt is transferred to the rollers that traction is reduced, creating erratic movements and causing the mouse to “skip” or “freeze”. This dramatically reduces the productivity of the computer user. The solution to this has been to disassemble and clean the part of the mouse where the trackball is housed or to replace the mouse entirely.

Attempts have been made in the past to produce a surface for a mouse pad that helps to reduce the amount of dirt and debris that gets transferred from the surface of the mouse pad to the inside of the mouse ball mechanism, as the mouse ball rides over the surface of the mouse pad. These attempts have had various levels of success, depending on the materials used and/or the design of the surface structure. None of these attempts have yet to completely solve the problem. The reason is that none of the materials used have been able to completely capture and hold the dirt and prevent it from eventually being transferred to the trackball and the mouse.

The MicroTracker Mouse Pad provides a new technology of utilizing the proper surface material for the mouse pad, virtually eliminating dirt from entering the trackball and interfering with the operation of the mouse. The MicroTracker Mouse Pad accomplishes this by utilizing a surface material called microfiber.

In order to be called “microfiber”, the fiber must be less than one denier. “Denier” is the term used to define the diameter of fineness of a continuous or filament fiber such as silk or man-made fibers. Denier is defined as the weight in grams of a 9000-meter length of fiber or yarn-the higher the number, the thicker the yarn. The majority of microfibers used today are between 0.1 and 0.3 denier, only 1/100 the size of a strand of hair.

The microfiber itself is cross-sectioned and can pick up and trap small particles of dirt within its microscopic grooves. Microfiber has been used for the past decade worldwide as a cleaning cloth due to it's remarkable properties of being able to trap and dirt and dust particles and the large internal surface area of the cloth, allowing it to hold and absorb up to seven times its weight in liquids and dirt.

The MicroTracker Mouse Pad is a Microfiber Cleaning Cloth Adhered to a Rubber Base, Making it a Microfiber High-performance Cleaning Cloth Mouse pad.

The MicroTracker Mouse Pad collects, traps and holds dust and dirt, preventing it from sticking on to the mouse trackball and entering the mouse. The wedge shape microfibers actually pull dirt into the matrix of the cloth, sweeping it internally between the microfibers. Microfiber are most commonly manufactured with a blend of polyester and nylon, however microfibers can be manufactured with virtually any type of fiber. It is important to note that polyester in and of itself does not possess any of the cleaning abilities of microfiber cloth. It is only through the process of extruding polyester and/or other materials into microfilaments does the polyester or other material exhibit the properties of high-performance cleaning cloths.

1. What I claim as my invention is the use of microfiber cloth, as defined in the specifications, as the surface material of a computer mouse pad.
The microfiber cloth is adhered to a rubber-like substance to create the mouse pad.
The microfiber material may be adhered to any number of different types of materials to create the mouse pad.
Regardless of how the mouse pad is created, if the mouse pad utilizes microfiber cloth as the surface material, it is protected by this claim.
Our trade name that we currently use for this invention is called “The MicroTracker Mouse Pad”, however we claim the right to use other trade names in the future for a mouse pad that utilizes microfiber cloth as the surface material.

2. What I claim as my invention is a mouse pad that is also a computer screen cleaning cloth, in one and the same product.
Whereas microfiber is the surface material used in the creation of the mouse pad invention called “The MicroTracker Mouse Pad”, as stated in claim I above, and whereas microfiber cloth is designed to clean fine grease, dust and dirt particles without harming delicate surfaces, the microfiber mouse pad can also be utilized to efficiently clean desktop, laptop or other computer screens.
